(19) United States
(12) Patent Application Publication
(10) Pub. No.: US 2005/0040787 A1
(43) Pub. Date: Feb. 24, 2005

(54) Portable computer

(75) Inventor: Yeong-bok Choi, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/912,563

(22) Filed: Aug. 6, 2004

(30) Foreign Application Priority Data
Aug. 6, 2003 (KR) 2003-54481

(51) Int. Cl. H02J 7/00

(52) U.S. Cl. 320/103

(57) ABSTRACT

A portable computer having a first battery pack and a second battery pack supplying electric power, and a system power supply supplying the electric power from either of the first battery pack or the second battery pack as system driving power, includes a first switching part allowing the electric power from the first battery pack to the system power supply to be supplied and broken, a first switching control circuit part turning on/off the first switching part to supply and break the electric power for the system power supply, a battery sensor sensing whether or not the second battery pack supplies the electric power to the system power supply; and a battery state output circuit controlling the first switching control circuit part to turn off the first switching part when the battery sensor determines that the second battery pack supplies the electric power to the system power supply.

### CROSS-REFERENCE TO RELATED APPLICATIONS

This application claims the benefit of Korean Patent Application No. 2003-54481, filed Aug. 6, 2003, in the Korean Intellectual Property Office, the disclosure of which is incorporated herein by reference.

### BACKGROUND OF THE INVENTION

1. Field of the Invention

The present invention relates to a portable computer, and more particularly, to a portable computer with an improved power supply system with a first battery and a second battery.

2. Description of the Related Art

Portable computers have developed into various forms including a laptop computer, a notebook computer, a Personal Digital Assistant (PDA), etc., and more variations are being developed because it is superior in portability to a desktop computer.

To enhance the portability of such portable computers, various methods to decrease the volume and weight of the portable computer have been developed. In addition, there are various methods that increase storage capacity and use time of a battery pack employed while the portable computer is carried.

As a method to enhance the portability, for example, the portable computer may include only essential components, and the other components such as a CD-ROM drive, an auxiliary hard disk drive, a floppy disk drive, etc., are provided in a docking station. In this case, a simplified portable computer is used while being carried, but can be used with various additional functions at a place such as an office, a home, etc., after being connected to the docking station.

Further, a dual battery mode can be used in the portable computer, in which two battery packs are used. That is, one of two battery packs (hereinafter referred to as a “first battery pack”) is mounted to the portable computer and employed in supplying electric power while the portable computer is carried, and the other one (hereinafter referred to as a “second battery pack”) is mounted to the docking station and employed together with the first battery pack in supplying the electric power while the portable computer is connected to the docking station, thereby increasing the use time.

In the conventional portable computer with the dual battery mode, when the portable computer is connected to the docking station and the electric power is supplied from both the first and second battery packs, one having higher voltage between two battery packs, i.e., one having more remaining power, is employed in supplying the electric power. For example, in the case where the first battery pack has more remaining power than the second battery pack, the electric power is supplied from the first battery pack. As the first battery pack is discharged, when the first battery pack has less remaining power than the second battery pack, the electric power is supplied from the second battery pack. Thus, two battery packs are employed in supplying the electric power, so that the two battery packs reach similar charge levels after a period of time has elapsed.

However, in the conventional portable computer, such a power supply system with the dual battery mode has the following problems.

First, suppose that the respective use times of the first and second battery packs are ten hours, and they are both in a fully charged state. In this condition, if the portable computer has been used for six hours when the portable computer is connected to the docking station, a user is likely to expect the first battery pack mounted to the portable computer to last ten hours when the portable computer is separated from the docking station and is used while being carried. However, in this case, the first battery pack can last approximately seven hours because the two battery packs are both partially discharged, so that it does not satisfy a user's expectation. Further, such a reduced use time of the portable computer is substantially disadvantageous to a user and a manufacturer.

Also, conventionally there is a reverse current prevention diode between the first battery pack and the second battery pack (or an adapter) to prevent the battery pack from being damaged by a reverse current. Because the electric power is supplied from the first and second battery packs through the reverse current prevention diode, power consumption is generated in the reverse current prevention diode.

### SUMMARY OF THE INVENTION

Accordingly, it is an aspect of the present invention to provide a portable computer in which a second battery pack is discharged prior to a first battery pack required while the portable computer is carried, so that it is convenient for a user and unwanted power consumption is reduced.

Additional aspects and/or advantages of the invention will be set forth in part in the description which follows and, in part, will be obvious from the description, or may be learned by practice of the invention.

The foregoing and/or other aspects of the present invention are achieved by providing a portable computer with a first battery pack and a second battery pack supplying electric power, and a system power supply supplying the electric power from either of the first battery pack or the second battery pack. The portable computer system includes a first switching part allowing the electric power from the first battery pack to the system power supply to be supplied or broken, a first switching control circuit part turning on/off the first switching part to supply or break the electric power for the system power supply, a battery sensor sensing whether or not the second battery pack supplies the electric power to the system power supply, and a battery state output circuit controlling the first switching control circuit part to turn off the first switching part when the battery sensor determines that the second battery pack supplies the electric power to the system power supply.

According to an embodiment of the invention, the portable computer includes a second switching part allowing the electric power supplied from the first battery pack to the system power supply to be supplied or broken; and a second switching control circuit part turning on/off the second switching part to supply or break the electric power for the system power supply.

According to an embodiment of the invention, the portable computer has a microcontroller controlling the second switching control circuit part to turn on/off the second switching part, so that the first and second switching parts are alternately turned on and off being reciprocal to each other.

According to an embodiment of the invention, the battery state output circuit receives a second battery power signal from the battery sensor corresponding to whether or not the second battery pack supplies the electric power to the system power supply, and outputs a first switching control signal based on the second battery power signal to the first switching control circuit part so as to determine whether to turn on or off the first switching part.

According to an embodiment of the invention, the first switching part includes a first main switching part allowing the electric power to be supplied or broken from the first battery pack to the system power supply, and a first auxiliary switching part having a first auxiliary switching element and a first reverse current prevention diode connecting with the first auxiliary switching element in parallel, and the first switching control circuit part includes a first main switching control circuit turning on/off the first main switching part on the basis of the first switching control signal output from the battery state output circuit, and a first auxiliary switching control circuit turning on/off the first auxiliary switching element of the first auxiliary switching part corresponding to control of the microcontroller.

According to an embodiment of the invention, the second switching part includes a second main switching part allowing the electric power to be supplied or broken from the second battery pack to the system power supply, and a second auxiliary switching part having a second auxiliary switching element and a second reverse current prevention diode connecting with the second auxiliary switching element in parallel, and the second switching control circuit part includes a second main switching control circuit turning on/off the second main switching part corresponding to the control of the microcontroller, and a second auxiliary switching control circuit controlled by the first main switching control circuit of the first switching control circuit part and turning on/off the second auxiliary switching element of the second auxiliary switching part.

According to an embodiment of the invention, the second battery power signal output from the battery sensor includes a battery sensing signal having a logical value corresponding to whether the second battery pack is mounted or not, and a station sensing signal having the logical value corresponding to whether a docking station to which the second battery is mounted is connected or not, and the battery state output circuit outputs the first switching control signal by logically operating the battery sensing signal and the station sensing signal.

According to an embodiment of the invention, the portable computer includes an adapter converting commercial AC power from the outside into DC power and supplying it to the system power supply; an adapter sensor sensing whether the electric power is supplied from the adapter or not; a discharge switching part allowing the electric power to be supplied or broken from the first battery pack and the second battery pack to the system power supply; and a discharge switching controller turning off the discharge switching part when the adapter sensor determines that the electric power is supplied from the adapter.

According to an embodiment of the invention, when the adapter sensor determines that the electric power is supplied from the adapter, the microcontroller controls the battery state output circuit to output the first switching control signal having the logical value to turn on the first switching part.

According to an embodiment of the invention, when the adapter sensor determines that the electric power is supplied from the adapter, the microcontroller controls the second main switching control circuit of the second switching control circuit part to turn on the second main switching part of the second switching part.

According to an embodiment of the invention, the battery state output circuit compares voltage of the electric power supplied from the second battery pack with predetermined reference voltage, and outputs the first switching control signal having the logical value to turn on the first switching part when the voltage of the electric power supplied from the second battery pack is lower than the reference voltage.

According to an embodiment of the invention, the microcontroller receives the first switching control signal outputted from the battery state output circuit, and controls the first auxiliary switching control circuit of the first switching control circuit part and the second main switching control circuit of the second switching control circuit part on the basis of the received first switching control signal.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a control block diagram of a portable computer according to an embodiment of the present invention;

FIG. 2 exemplarily illustrates a battery sensor of FIG. 1;

FIG. 3 exemplarily illustrates a detailed configuration of a battery state output circuit of FIG. 1 for a second battery;

FIG. 4 exemplarily illustrates a detailed configuration of a first switching part and a first switching control circuit part of FIG. 1; and

FIG. 5 exemplarily illustrates a detailed configuration of a second switching part and a second switching control circuit part of FIG. 1.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

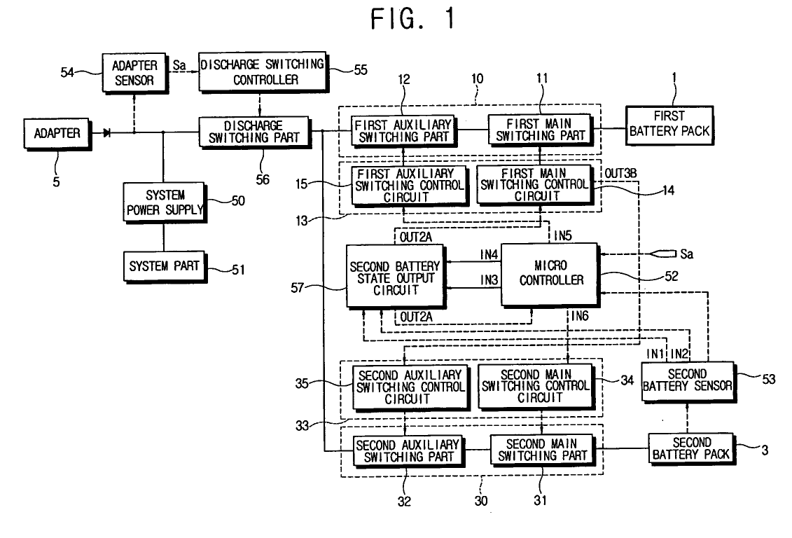

As shown in FIG. 1, a portable computer system according to the present invention comprises a system part 51 including a plurality of electronic components such as a central processing unit (CPU), a main board, a memory, etc., performing a computer system main function; first and second battery packs 1 and 3 supplying electric power; a system power supply 50 supplying the electric power output from the first and second battery packs 1 and 3 to the system part 51 so as to drive the system part 51.

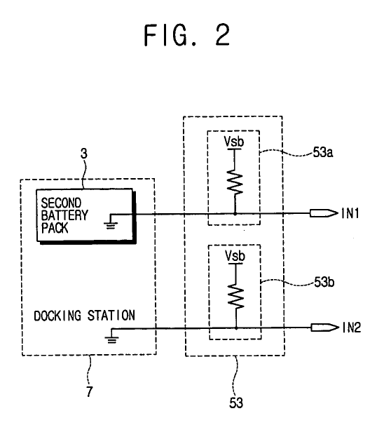

The first battery pack 1 according to an embodiment of the present invention is mounted to a portable computer including the system part 51, and supplies the electric power to the system power supply 50 while the portable computer is carried. The second battery pack 3 is mounted to a removable device such as a docking station 7 (refer to FIG. 2) that is removable from the portable computer, and supplies the electric power to the system power supply 50 when the portable computer is connected to the removable device.

Further, the portable computer according to the present invention has a first switching part 10 allowing the electric power supply path from the first battery pack 1 to the system power supply 50 to be connected or broken. A first switching control circuit part 13 turns the first switching part 10 on/off to control the first switching part 10 to supply or break the electric power for the system power supply 50. A battery sensor 53 senses whether or not the second battery pack 3 is supplying the electric power to the system power supply 50 and a battery state output circuit 57 controls the first switching control circuit part 13 to turn off the first switching part 10 when the battery sensor 53 determines that the second battery pack 3 is supplying the electric power to the system power supply 50. Here, the battery state output circuit 57 receives second battery power signals IN1 and IN2 from the battery sensor 53 corresponding to whether or not the second battery pack 3 supplies the electric power to the system power supply 50, and outputs a first switching control signal OUT2A based on the second battery power signals IN1 and IN2 to the first switching control circuit part 13, thereby determining whether the first switching control circuit part 13 has to turn on or off the first switching part 10.

The battery sensor 53 senses whether or not the second battery pack 3 is mounted to the docking station 7 and whether or not the portable computer is connected to the docking station 7, thereby determining whether or not the second battery pack 3 supplies the electric power to the system power supply 50. Here, the battery sensor 53, as shown in FIG. 2, includes a battery sensing circuit 53i a sensing whether or not the second battery pack 3 is mounted to the docking station 7 and outputting a battery sensing signal IN1 as a corresponding logical value, and a station sensing circuit 53b sensing whether or not the portable computer is connected to the docking station 7 and outputting a station sensing signal IN2 as a corresponding logical value. Thus, the battery sensor 53 outputs the second battery power signals including the battery sensing signal IN1 and the station sensing signal IN2 to the battery state output circuit 57.

The battery state output circuit 57 changes the battery sensing signal IN1 and the station sensing signal IN2 output from the battery sensor 53 into the first switching control signal OUT2A by a logical operation. Here, the battery state output circuit 57 outputs the first switching control signal OUT2A having a logical value to turn off the first switching part 10 when the battery sensing signal IN1 and the station sensing signal IN2 have the logical values corresponding to a state when the second battery pack 3 is mounted to the docking station 7 and the portable computer is connected to the docking station 7, respectively. Oppositely, the battery state output circuit 57 outputs the first switching control signal OUT2A having the logical value to turn on the first switching part 10 when the battery sensing signal IN1 and the station sensing signal IN2 have the logical values corresponding to a state when at least one of the second battery pack 3 and the portable computer is separated from the docking station 7, respectively. Thus, in the case where the second battery pack 3 can supply the electric power to the system power supply 50, the path for electric power supplied from the first battery pack 1 is broken, thereby discharging only the second battery pack 3. Oppositely, in the case where the second battery pack 3 cannot supply the electric power to the system power supply 50, that is, where at least one of the second battery pack 3 and the portable computer is separated from the docking station 7, the first battery pack 1 is discharged, thereby supplying the electric power to the system part 51.

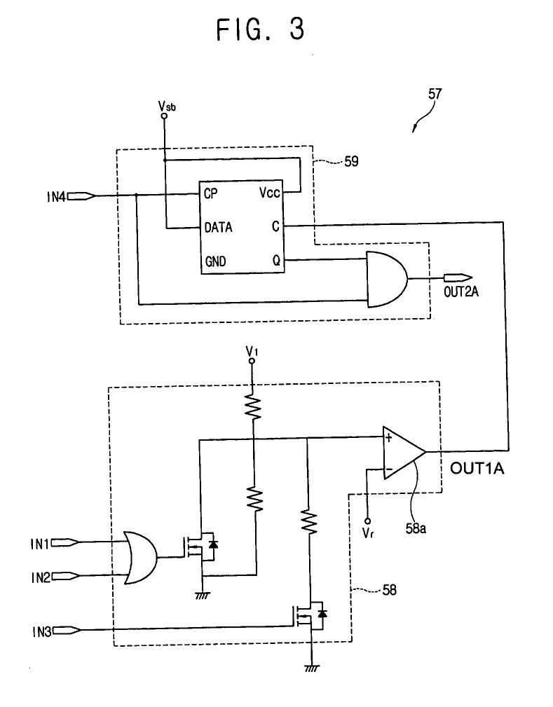

FIG. 3 exemplarily illustrates a detailed configuration of the battery state output circuit 57 according to an embodiment of the present invention. As shown therein, the battery state output circuit 57 includes a logical operation circuit 58 changing the battery sensing signal IN1 and the station sensing signal IN2 output from the battery sensor 53 into a logical signal OUT1A by a logical operation. Here, the logical operation circuit 58 includes a comparator 58a comparing a predetermined reference voltage Vr with a voltage V1 applied to the system power supply 50 when the electric power is supplied from the second battery pack 3 to the system power supply 50. When it is determined that the voltage V1 of the electric power supplied from the second battery pack 3 to the system power supply 50 is lower than the reference voltage Vr, the comparator 58a outputs the logical signal OUT1A having a logical value to turn on the first switching part 10. Thus, when the voltage V1 of the electric power supplied from the second battery pack 3 is lower than the reference voltage Vr, the electric power is supplied from the first battery pack 1.

Further, the logical operation circuit 58 of the battery state output circuit 57 receives a second battery type information signal IN3 corresponding to a type of the second battery pack 3 from a microcontroller 52, and varies the voltage V1 of the electric power supplied from the second battery pack 3. Here, the second battery type information signal IN3 contains information about the type of the second battery pack 3, for example, capacity, the number of cells, etc. In this embodiment, the microcontroller 52 outputs the second battery type information signal IN3 based on the type of the second battery pack 3 sensed by the battery sensor 53.

Meanwhile, the battery state output circuit 57 according to an embodiment of the present invention includes a battery selection part 59 outputting a battery selection signal IN4 from the microcontroller 52, and the first switching control signal OUT2A based on the logical signal OUT1A output from the logical operation circuit 58. Here, when a user selects the first battery pack 1 through a selection program or a selection button provided in the portable computer, the battery selection signal IN4 having a corresponding logical value is output from the microcontroller 52 and transmitted to the battery selection part 59. When the battery selection signal IN4 having a logical value corresponding to a state when the first battery pack 1 is selected is output from the microcontroller 52, the battery selection part 59 outputs the first switching control signal OUT2A to turn on the first switching part 10 regardless of the logical signal OUT1A output from the logical operation circuit 58. Thus, a user can selectively discharge the first battery, so that it is convenient for the user.

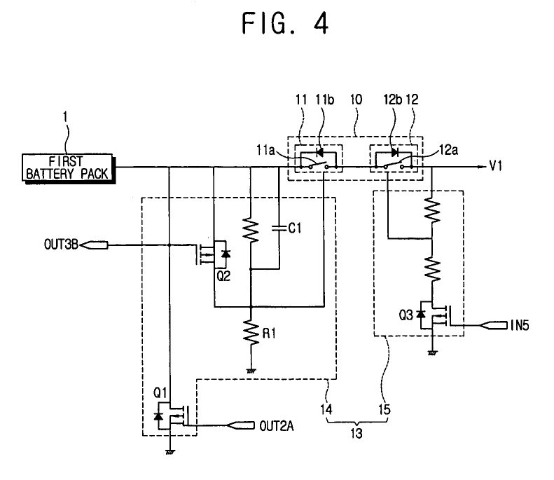

FIG. 4 illustrates a detailed configuration of the first switching part 10 and the first switching control circuit part 13 according to an embodiment of the present invention. As shown therein, the first switching part 10 includes a first main switching part 11 allowing the electric power to be supplied or broken from the first battery pack 1 to the system power supply 50, and a first auxiliary switching part 12 having a first auxiliary switching element 12a and a first reverse current prevention diode 12b, connecting with the first auxiliary switching element 12a in parallel. Further, the first switching control circuit part 13 includes a first main switching control circuit 14 turning on/off the first main switching part 11 on the basis of the first switching control signal OUT2A output from the battery state output circuit 57, and a first auxiliary switching control circuit 15 turning on/off the first auxiliary switching element 12a of the first auxiliary switching part 12 corresponding to the control of the microcontroller 52.

The first main switching part 11 includes a first main switching element 11a controlled by the first switching control circuit part 13 to be turned on/off, and a diode 11b connecting with the first main switching element 11a in parallel. Here, when the first main and auxiliary switching elements 11a and 12a are turned on and off respectively, the electric power from the first battery pack 1 is supplied to the system power supply 50, passing through the first main switching element 11a and the first reverse current prevention diode 12b. When the first main and auxiliary switching elements 11a and 12a are both turned on, the electric power from the first battery pack 1 is supplied to the system power supply 50, passing through the first main switching element 11a and the first auxiliary switching element 12a. When the first main and auxiliary switching elements 11a and 12a are both turned off, the electric power from the first battery pack 1 is broken, and the reverse electric power from an adapter 5 (to be described later) or the second battery pack 3 is broken by the first reverse current prevention diode 12b. Thus, when the electric power is supplied from the first battery pack 1, the first main and auxiliary switching elements 11a and 12a are turned on, so that the electric power is prevented from being supplied through the first reverse current prevention diode 12b, thereby preventing unwanted power consumption.

The first main switching control circuit 14 of the first switching control circuit part 13 includes switching elements Q1 and Q2 that are turned on/off according to the first switching control signal OUT2A output from the battery state output circuit 57. Signal delaying elements C1 and R1 delay alternating between turning on and off the first main switching element 11a corresponding to the logical values of the first switching control signal OUT2A. Here, the signal delaying elements C1 and R1 delay turning on the first switching element from when the logical value of the first switching control signal OUT2A is received for a predetermined amount of time, so that a second switching element (to be described later) and the first switching element are not simultaneously turned on, thereby preventing the electric power from interfering due to simultaneously turning on the first battery pack 1 and the second battery pack 3.

The first auxiliary switching control circuit 15 of the first switching control circuit part 13 includes a switching element Q3 that is turned on/off according to a control signal IN5 from the microcontroller 52. Here, the first auxiliary switching part 12 is turned on/off according to turning on/off the switching element Q3 of the first auxiliary switching control circuit 15.

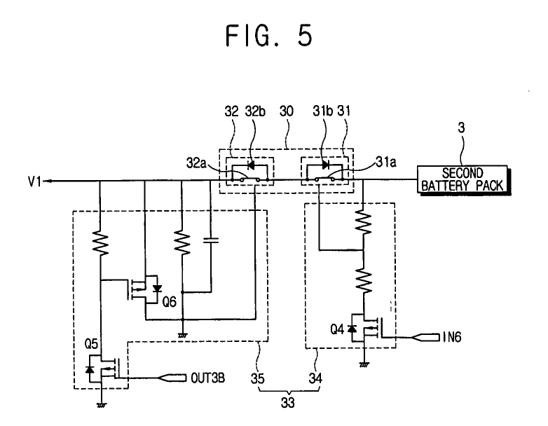

As shown in FIGS. 1 and 5, the portable computer includes a second switching part 30 allowing the electric power supplied from the second battery pack 3 to the system power supply 50 to be supplied or broken; and a second switching control circuit part 33 turning on/off the second switching part 30 so as to control the second switching part 30 to supply or break the electric power to the system power supply 50. Here, the microcontroller 52 receives the first switching control signal OUT2A from the battery state output circuit 57, and controls the second switching control circuit part 33 to turn on/off the second switching part 30 so as to alternately turn on/off the first switching part 10 and the second switching part 30.

The second switching part 30 includes a second main switching part 31 allowing the electric power to be supplied or broken from the second battery pack 3 to the system power supply 50, and a second auxiliary switching part 32 having a second auxiliary switching element 32a and a second reverse current prevention diode 32b connecting with the second auxiliary switching element 32a in parallel. A second main switching part 31 has a diode 31b in parallel with the second main switching element 31a. Here, the second main and auxiliary switching parts 31 and 32 of the second switching part 30 have the same function as the first main and auxiliary switching parts 11 and 12 of the first switching part 10, so that their descriptions will be omitted.

Further, the second switching control circuit part 33 includes the second main switching control circuit 34 turning on/off the second main switching part 31 according to control of the microcontroller 52, and a second auxiliary switching control circuit 35 controlled by the first main switching control circuit 14 of the first switching control circuit part 13 and turning on/off the second auxiliary switching element 32a of the second auxiliary switching part 32.

The second main switching control circuit 34 of the second switching control circuit part 33 turns on/off the second main switching part 31 according to the control of the microcontroller 52. Here, the microcontroller 52 outputs a control signal IN6 on the basis of the first switching control signal OUT2A from the battery state output circuit 57 so as to control the second main switching control circuit 34, thereby turning on/off the second switching control circuit part 33. The second main switching control circuit 34 includes a switching element Q4 being turned on/off according to the control signal IN6 from the microcontroller 52.

The second auxiliary switching control circuit 35 of the second switching control circuit part 33 turns on/off the second auxiliary switching part 32 according to the control of the first main switching control circuit 14 of the first switching control circuit part 13. That is, the first main switching control circuit 14 of the first switching control circuit part 13 outputs a second switching control signal OUT3B corresponding to the logical value of the first switching control signal OUT2A output from the battery state output circuit 57. The first switching control signal OUT2A and the second switching control signal OUT3B are logically reciprocal to each other. The second switching control signal OUT3B output from the first main switching control circuit 14 of the first switching control circuit part 13 is sent to the second switching control circuit part 33, and turns on/off the switching elements Q5 and Q6 included in the second switching control circuit part 33, thereby turning on/off the second auxiliary switching part 32. Here, when the first battery pack 1 is turned off, that is, when the first main switching part 11 of the first switching part 10 is turned off, the microcontroller 52 controls the second main switching control circuit 34 of the second switching control circuit part 33 to turn on the second main switching part 31 to control the second battery pack 3 to supply the electric power to the system power supply 50, and the first main switching control circuit 14 of the first switching control circuit part 13 sends the second switching control signal OUT3B to the second auxiliary switching control circuit 35 of the second switching control circuit part 33 so as to turn on the second auxiliary switching part 32. Thus, the electric power is supplied from the second battery pack 3 to the system power supply 50 through the second main switching element 31a of the second main switching part 31 and the second auxiliary switching element 32a of the second auxiliary switching part 32, thereby preventing power consumption in the second reverse current prevention diode 32b.

As shown in FIG. 1, the portable computer includes the adapter 5 converting commercial alternating current (AC) power from the outside into direct current (DC) power and supplying it to the system power supply 50. An adapter sensor 54 senses whether electric power is supplied from the adapter 5. A discharge switching part 56 controls the electric power path from the first battery pack 1 and the second battery pack 3 to the system power supply 50, and a discharge switching controller 55 turns off the discharge switching part 56 when the adapter sensor 54 determines that electric power is supplied from the adapter 5. Thus, when the adapter 5 is connected to the portable computer according to the present invention, electric power is supplied from the adapter 5, and the electric power path from the first and second battery packs 1 and 3 is broken.

Further, when the adapter sensor 54 determines that electric power is supplied from the adapter 5, the microcontroller 52 receives an adapter sensing signal Sa from the adapter sensor 54 and controls the battery state output circuit 57 to output the first switching control signal OUT2A having the logical value allowing the first switching control circuit part 13 to be turned on. Also, when the adapter sensor 54 determines that electric power is supplied from the adapter 5, the microcontroller 52 controls the second main switching control circuit 34 of the second switching control circuit part 33 to turn on the second main switching part 31 of the second switching part 30. Thus, the first switching part 10 and the second switching part 30 are turned on while electric power is supplied from the adapter 5. Thus, electric power can be supplied from the first and second battery packs 1 and 3 as soon as electric power from the adapter 5 is broken, for example, when the adapter 5 is unplugged. Here, when the adapter sensor 54 determines that electric power is supplied from the adapter 5, the microcontroller 52 receives the adapter sensing signal Sa from the adapter sensor 54 and converts the logical value of the battery selection signal IN4 output from the battery state output circuit 57, thereby controlling the battery state output circuit 57 to output the first switching control signal OUT2A having the logical value to turn on the first switching control circuit part 13.

When the portable computer is supplied with electric power from the first battery pack 1 and not the second battery pack 3 and the adapter 5, the first main and auxiliary switching parts 11 and 12 of the first switching part 10 are maintained in the on or closed state.

In this state, if the second battery pack 3 is connected to the portable computer, for example, when the second battery pack 3 is mounted while the docking station 7 is connected to the portable computer or when the docking station 7 is connected to the portable computer while the being mounted with the second battery pack 3, the battery sensor 53 senses the second battery pack 3 or the docking station 7, and the logical values of the battery and station sensing signals IN1 and IN2 output from the battery state output circuit 57 are converted into ‘0’.

Then, the logical operation circuit 58 of the battery state output circuit 57 logically operates the battery sensing signal IN1 and the station sensing signal IN2 and outputs the logical signal OUT1A having the logical value of ‘1’ to the battery selection part 59. Then, the battery selection part 59 outputs the first switching control signal OUT2A having the logical value of ‘1’ on the basis of the battery selection signal IN4 output from the microcontroller 52 and the logical signal OUT1A. Here, the logical value of the battery selection signal IN4 is ‘1’ as a default value.

Then, the first switching control signal OUT2A having the logical value of ‘1’ output from the battery selection part 59 of the battery state output circuit 57 is transmitted to the first main switching control circuit 14 of the first switching control circuit part 13, thereby turning off the first main switching part 11 of the first switching part 10. At this time, the first main switching control circuit 14 outputs the second switching control signal OUT3B having the logical value of ‘0’.

Meanwhile, the microcontroller 52 senses the first switching control signal OUT2A having the logical value of ‘1’ output from the battery state output circuit 57, and controls the first auxiliary switching control circuit 15 to turn off the first auxiliary switching part 12. Further, the microcontroller 52 controls the second main switching control circuit 34 of the second switching control circuit part 33 to turn on the second main switching part 31 of the second switching part 30. Therefore, the first switching part 10 is turned off, and the second switching part 30 is turned on, so that electric power is supplied from the second battery pack 3 to the system power supply 50.

Further, the second switching control signal OUT3B having the logical value ‘0’ output from the first main switching control circuit 14 is transmitted to the second auxiliary switching control circuit 35 of the second switching control circuit part 33, thereby turning on the second auxiliary switching part 32. Thus, electric power is supplied from the second battery pack 3 to the system power supply 50 through the respective switching elements included in the second main switching part 31 and the second auxiliary switching part 32.

Further, while electric power is supplied from the second battery pack 3, if the docking station 7 or the second battery pack 3 is separated from the portable computer and there is no electric power from the second battery pack 3, the battery sensor 53 outputs the battery sensing signal IN1 or the station sensing signal IN2 having the logical value ‘1’ to the battery state output circuit 57. Thus, while the first switching part 10 is turned off and the second switching part 30 is turned on, the logical values of the respective signals are reciprocally reversed, so that the second switching part 30 is turned off and the first switching part 10 is turned on.

Further, while electric power is supplied from either the first battery pack 1 or the second battery pack 3, if the adapter 5 is mounted and starts supplying electric power, the adapter sensor 54 senses this, and the discharge switching controller 55 turns off the discharge switching part 56, so that electric power from the first or second battery packs 1 or 3 is cut off. At this time, when the adapter sensor 54 determines that electric power is supplied from the adapter 5, the microcontroller 52 controls the first and second main switching parts 11 and 31 to turn on, and controls the first and second auxiliary switching parts 12 and 32 to turn off. Regardless of whether adapter sensor 54 determines that electric power is supplied from the adapter 5, the microcontroller 52 changes the logical value of the battery selection signal IN4 into ‘0’ and changes the logical value of the first switching control signal OUT2A into ‘1’, so that the first main switching part 11 is turned on and the second auxiliary switching part 32 is turned off. It is understood that the discharge switching controller 55 function of switching the discharge switching part 56 on/off could be implemented by the microcontroller 52 using a signal from the adapter sensor 54.

In the above-described embodiment, the second battery pack 3 is mounted to a removable device such as the docking station 7. However, the second battery pack 3 may be removably mounted to the portable computer. In this case, the battery sensor outputs only the battery sensing signal to the battery state output circuit, and the battery state output circuit changes the first switching control signal in the logical value corresponding to the battery sensing signal.

As described above, there are provided a first switching part allowing electric power from the first battery pack to the system power supply to be supplied or broken; a first switching control circuit part turning on/off the first switching part to supply or break electric power for the system power supply; a battery sensor sensing whether or not the second battery pack supplies the electric power to the system power supply; and a battery state output circuit controlling the first switching control circuit part to turn off the first switching part when the battery sensor determines that the second battery pack supplies the electric power to the system power supply, so that the second battery pack is discharged prior to the first battery pack that is used while the portable computer is carried, so that it is convenient for a user.

Further, the first switching part and the second switching part include the first main and auxiliary switching parts and the second main and auxiliary switching parts, respectively, so that the unwanted power consumption generated in the reverse current prevention diode is reduced.

Additionally, it is understood that the first and second battery packs may be configured differently while still using the circuitry and controls of the present invention. For example, the first and second battery packs may be located together in the portable electronic device for additional run time or the first battery pack could be located in the portable electronic device while the second battery pack is located in the docking station.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A portable computer comprising a first battery pack and a second battery pack supplying electric power, and a system power supply supplying the electric power selectively from the first battery pack and the second battery pack as system driving power, further comprising:
a first switching part allowing the electric power from the first battery pack to the system power supply to be supplied or broken;
a first switching control circuit part turning on/off the first switching part to supply or break the electric power for the system power supply;
a battery sensor sensing whether the second battery pack supplies the electric power to the system power supply; and
a battery state output circuit controlling the first switching control circuit part to turn off the first switching part when the battery sensor determines that the second battery pack supplies the electric power to the system power supply.

2. The portable computer according to claim 1, further comprising:
a second switching part allowing the electric power supplied from the second battery pack to the system power supply to be supplied or broken; and
a second switching control circuit part turning on/off the second switching part to supply or break the electric power for the system power supply.

3. The portable computer according to claim 2, further comprising a microcontroller controlling the second switching control circuit part to turn on/off the second switching part, so that the first and second switching parts are alternately turned on and off so as to be reciprocal to each other.

4. The portable computer according to claim 3, wherein the battery state output circuit receives a battery power signal from the battery sensor corresponding to whether the second battery pack supplies the electric power to the system power supply, and outputs a first switching control signal based on the battery power signal to the first switching control circuit part to control turning on and off the first switching part.

5. The portable computer according to claim 4, wherein the first switching part comprises a first main switching part allowing the electric power to be supplied and broken from the first battery pack to the system power supply, and a first auxiliary switching part having a first auxiliary switching element and a first reverse current prevention diode connecting with the first auxiliary switching element in parallel; and
the first switching control circuit part comprises a first main switching control circuit turning on/off the first main switching part based upon the first switching control signal outputted from the battery state output circuit, and a first auxiliary switching control circuit turning on/off the first auxiliary switching element of the first auxiliary switching part corresponding to control of the microcontroller.

6. The portable computer according to claim 5, wherein the second switching part comprises a second main switching part allowing the electric power to be supplied and broken from the second battery pack to the system power supply, and a second auxiliary switching part having a second auxiliary switching element and a second reverse current prevention diode connecting with the second auxiliary switching element in parallel; and
the second switching control circuit part comprises a second main switching control circuit turning on/off the second main switching part corresponding to the control of the microcontroller, and a second auxiliary switching control circuit controlled by the first main switching control circuit of the first switching control circuit part and turning on/off the second auxiliary switching element of the second auxiliary switching part.

7. The portable computer according to claim 4, wherein the battery power signal output from the battery sensor includes a battery sensing signal having a logical value corresponding to whether the second battery pack is mounted, and a station sensing signal having a logical value corresponding to whether a docking station to which the second battery is mounted is connected, and
the battery state output circuit outputs the first switching control signal by logically operating the battery sensing signal and the station sensing signal.

8. The portable computer according to claim 7, further comprising:
an adapter converting commercial AC power into DC power and supplying the DC power to the system power supply;
an adapter sensor sensing whether the electric power is supplied from the adapter;
a discharge switching part allowing the electric power to be supplied and broken from the first battery pack and the second battery pack to the system power supply; and
a discharge switching controller turning off the discharge switching part when the adapter sensor determines that the electric power is supplied from the adapter.

9. The portable computer according to claim 8, wherein when the adapter sensor determines that the electric power is supplied from the adapter, the microcontroller controls the battery state output circuit to output the first switching control signal having a logical value to turn on the first switching part.

10. The portable computer according to claim 8, wherein when the adapter sensor determines that the electric power is supplied from the adapter, the microcontroller controls the second main switching control circuit of the second switching control circuit part to turn on the second main switching part of the second switching part.

11. The portable computer according to claim 4, wherein the battery state output circuit compares a voltage of the electric power supplied from the second battery pack with a predetermined reference voltage, and outputs the first switching control signal having a logical value to turn on the first switching part when the voltage of the electric power supplied from the second battery pack is lower than the reference voltage.

12. The portable computer according to claim 6, wherein the microcontroller receives the first switching control signal output from the battery state output circuit, and controls the first auxiliary switching control circuit of the first switching control circuit part and the second main switching control circuit of the second switching control circuit part based upon the received first switching control signal.

13. A power supply system for a portable electronic device comprising:
a main battery pack;
a secondary battery pack;
a main switching circuit switching power from the main battery pack to the portable electronic device;
a secondary switching circuit switching power from the secondary battery pack to the portable electronic device; and
a controller controlling the main switching circuit and the secondary switching circuit, wherein the main switching circuit is switched off and the secondary switching circuit is switched on when the second battery back is supplying power within a predetermined voltage range, and the secondary switching circuit is switched off and the main switching circuit is switched on when the second battery pack is not supplying power within the predetermined voltage range, to supply power from the secondary battery pack and the main battery pack, respectively.

14. The system according to claim 13, further comprising:
a docking station to couple with the portable electronic device, wherein the first battery pack is in the portable electronic device and the second battery pack is in the docking station.

15. The system according to claim 14, wherein the main switching circuit is switched off when the portable electronic device is coupled to the docking station so that the second battery pack is discharged prior to the first battery pack.

16. The system according to claim 14, wherein when the portable electronic device is not coupled to the docking station the main battery pack is supplying power through the main switching circuit.

17. The system according to claim 13, wherein the controller comprises:
sensors to sense the secondary battery pack and output sensor signals;
a battery state output circuit to output control signals to selectively switch off the main switching circuit when the second battery pack is supplying power; and
a microcontroller to selectively control the secondary switching circuit based on the sensor signals and the control signals output from the sensors and the battery state output circuit, respectively.

18. The system according to claim 13, further comprising:
an AC/DC adapter to supply power to the portable electronic device;
a discharge switching part switching power from the AC/DC adapter, wherein the controller switches off the main switching circuit and the secondary switching circuit and switches on the discharge switching part when the AC/DC adapter is supplying power to the portable electronic device.

19. The system according to claim 18, wherein the main switching circuit comprises:
a main switch element to switch power from the main battery pack;
an auxiliary switch element to switch power from the main battery pack in combination with the main switch element; and
a reverse current prevention diode in parallel with the auxiliary switch element, wherein when the main switching circuit is switched off by the controller, the main switch element is open and the auxiliary switch element is open and the reverse current prevention diode prevents a reverse current from reaching the main battery pack, and when the main switching circuit is switched on by the controller, the main switch element is closed and the auxiliary switch element is closed to permit current to flow from the main battery pack to the portable electronic device and bypass the reverse current protection diode to reduce power consumption of the main battery pack.

20. The system according to claim 19, wherein the secondary switching circuit comprises:
a secondary switch element to switch power from the secondary battery pack;
an secondary auxiliary switch element to switch power from the secondary battery pack in combination with the secondary switch element; and
a reverse current prevention diode in parallel with the secondary auxiliary switch element, wherein when the secondary switching circuit is switched off by the controller, the secondary switch element is open and the secondary auxiliary switch element is open and the reverse current prevention diode prevents a reverse current from reaching the secondary battery pack, and when the secondary switching circuit is switched on by the controller, the secondary switch element is closed and the auxiliary switch element is closed to permit current to flow from the secondary battery pack to the portable electronic device and bypass the reverse current protection diode to reduce power consumption of the secondary battery pack.

21. The system according to claim 20, wherein the controller comprises:
a plurality of sensors to sense the secondary battery pack and the AC/DC adapter and output sensor signals;
a main switching control circuit to selectively switch the main switching circuit;
a secondary switching control circuit to selectively switch the secondary circuit;
a battery state output circuit to output control signals to control the main switching control circuit; and
a microcontroller to selectively control the secondary switching control circuit based on the sensor signals and the control signals output from the sensors and the battery state output circuit, respectively.

22. The system according to claim 21, further comprising:
an input device, wherein a user inputs a signal to the controller to select one of the main battery pack, the secondary battery pack, and the AC/DC adapter to supply power to the portable electronic device.

23. The system according to claim 21, wherein the main switching control circuit outputs a signal to control the secondary auxiliary switch element, and the microcontroller outputs a signal to control the secondary switch element in response to the secondary switching control circuit.
